(19) United States
(12) Patent Application Publication
(10) Pub. No.: US 2012/0101740 A1
(43) Pub. Date: Apr. 26, 2012

(54) METHOD, INSTRUMENT AND COMPUTER PROGRAM PRODUCT FOR QUANTIFICATION OF PCR PRODUCTS

(75) Inventors: Arto Orpana, Saltsjo-Duvnas (SE); Jakob Stenman, Saltsjo-Duvnas (SE)

(73) Assignee: Expression Analytics OY, Espoo (FI)

(21) Appl. No.: 13/319,076

(22) PCT Filed: May 4, 2010
(86) PCT No.: PCT/FI2010/050360

§ 371 Date: Jan. 5, 2012

(30) Foreign Application Priority Data
May 7, 2009 (FI) 20095514

(51) Int. Cl. G06F 19/10

(52) U.S. Cl. 702/21; 702/19

(57) ABSTRACT

This document relates to melting curve analysis of nucleic acids. The method according to first aspect of the invention comprises analyzing a nucleic acid melting curve measured from a sample, the melting curve comprising a sum signal of at least two nucleic acid melt signals and a background signal as a function of temperature. The method further comprises optimizing at least one constant in a temperature-dependent exponential correction function so as to minimize the variation of the nucleic acid melting curve at a temperature region where the target nucleic acids in the sample remain essentially double stranded, and generating a corrected nucleic acid melting curve representative of the nucleic acid melt signal by applying said exponential correction function over the region of the measured melting curve where the strands of the nucleic acids dissociate. According to further aspects, the invention relates to a curve fitting algorithm for precise estimation of melting peak areas and a mathematical transformation for linearization of calibration curve data to enhance the linear measuring range of a competitive PCR assay. The invention provides a powerful tool for analyzing PCR-amplified sample containing two or more different nucleic acids having similar but distinguishable melting temperature.

### FIELD OF THE INVENTION

The present invention relates to nucleic acid melting curve analysis. More specifically the embodiments of the present invention relate to the methods and systems for removing background signals and extracting specific signals in melting profiles of double stranded nucleic acids.

Melting curve analysis is typically performed in conjunction with polymerase chain reaction (PCR) for analysis of amplification products. The present invention thus also relates to instruments and software for melting curve analysis and real-time and competitive PCR techniques.

### BACKGROUND OF THE INVENTION

Melting curve analysis is based on measurement of the temperature-dependent dissociation of double stranded nucleic acids, typically DNA, in a solution. The energy required for dissociation of the hydrogen bonds between the two strands is dependent on the length and base composition of the double stranded DNA molecules and on the complementarity of the opposing strands. The dissociation of the strands can be monitored using probes that change their fluorescent properties upon binding to nucleic acids, or fluorescent dyes that fluoresce when bound to double-stranded DNA but cease to fluoresce when DNA dissociates into single-stranded molecules. Thus, the amount of double stranded DNA present in a sample can be measured by optically monitoring the amount of fluorescence while increasing the temperature in a sample.

If the sample contains multiple groups of double stranded DNA molecules of different length or with a differing nucleotide composition, the result of the measurement will comprise a sum of temperature-dependent fluorescent signals that are specific for each of the analyzed groups of DNA molecules. Thus, when measuring the PCR amplicons in a sample subsequent to PCR amplification of two or multiple templates, specific temperature-dependent fluorescent signals can be obtained for each of the specific PCR amplicons present in the sample.

In addition there is typically a decrease in fluorescent signal with an increasing temperature that occurs regardless of the temperature-specific dissociation of double stranded DNA molecules. This decrease in fluorescent signal can typically be observed over the whole temperature range, especially at temperatures where the DNA molecules in the sample remain essentially double stranded. This background signal is dependent on the amount of double stranded DNA present in the sample and it decreases exponentially as the temperature of the sample increases. The measured signal thus, comprises the specific decrease in fluorescent signal obtained from dissociation of double stranded DNA in the sample and of a temperature dependent exponentially decreasing background signal.

Real-time PCR involves amplification of cDNA or DNA templates and quantitative measurement of the amount of amplified DNA amplicons. In this technique the accumulation of PCR product in the reaction is monitored during each cycle of PCR amplification. The amount of template DNA present in a sample can be determined by comparing accumulation of reaction products in a sample to accumulation of reaction products in known standards. Additionally reaction efficiencies can be determined based on accumulation kinetics, but accuracy of such calculation is typically compromised by limited data points. Competitive PCR provides an alternative approach to control the variations in amplification efficiency between separate reaction vials. In this technique a known amount of a reference DNA template that differs in length or nucleotide composition from the wild type cDNA or DNA template, is included in the reaction and co-amplified with the wild type template in the same reaction vial. The relative amounts of wild type and reference PCR amplicons are determined subsequently to amplification. As, the amplification reaction efficiency influences both wild type and reference templates equally, the amount of wild type template originally present in the sample can be determined from the relative amounts of wild type and reference PCR amplicons. In real-time PCR, quantitative measurement is performed during amplification, whereas in competitive PCR it is typically performed after completion of the amplification reaction.

Diagnostic tests based on RNA-expression analysis are faced with several technical challenges. A specific challenge has been the analysis of formalin-fixed paraffin-embedded (FFPE) tissue samples, in which the RNA molecules have been degraded into shorter fragments. Extraction and amplification of these short RNA fragments is technically demanding and the obtained signals are typically low. Genome-controlled RT-PCR has been used successfully for this purpose (Stenman et al., Clinical Chemistry 52:11 1988-1996 (2006)). This technique is based on competitive PCR and enables amplification and quantitative measurement of short cDNA fragments, making it suitable for analysis of mRNA expression in FFPE samples. After competitive PCR amplification, the relative amounts of PCR amplicons originating from wild type cDNA and reference DNA templates are measured using melting curve analysis. In this technique the PCR amplicons generated from the wild type cDNA and reference DNA templates differ in nucleotide composition and differential detection is based on slight differences in the melting temperature. There are several specific benefits of this technique. Using genome-controlled RT-PCR it is possible to amplify exceptionally short cDNA fragments generated from mRNA of virtually any gene, as differentiation between expressed and genomic sequences is not dependent on intronic sequences. This is essential when analyzing FFPE samples. Co-amplification of a reference DNA template in every reaction regardless of the amount of wild type cDNA template present increases the reproducibility of the assay. The detection limit and imprecision of the assay can be controlled by varying the amount of the reference template, which is essential for diagnostic applications. Also, carryover of genomic DNA from the RNA extraction step does not cause false positive result following amplification. The requirements on the quantitative properties of the melting curve analysis in this type of assay are exceptionally high, as the relative levels of PCR products with close-to-equal melting temperatures are precisely quantified over a measuring range spanning several decades.

An instrument for rapid PCR amplification and detection of PCR products based on melting temperature is described in WO 1997/046712. The principle of melting curve analysis based on fluorescence measurements is extensively described in publications WO 2000/066777, WO 2004/038038 and WO 2006/121423. Extraction of qualitative and quantitative data from melting curve spectra typically involves measuring the fluorescent signal as a function of temperature to produce a raw melting curve. By calculating the rate of the change in signal as a function of temperature, a first derivative curve that displays dissociation of specific double stranded DNAs as specific “melting peaks”, can be generated. A problem of this type of analysis is, however, the background signal, which affects the size and baseline of the separate melting peaks in the spectrum and complicates quantitative analysis especially when multiple peaks are present in the same spectra. In publication WO 2007/035806, an improvement of the analytical procedure is described in which the background signal is subtracted from the nucleic acid sample signal. In this technique an exponential algorithm is derived by interpolation from two separate slope values taken from points before and/or after the nucleic acid melting transition. This algorithm is then used to generate a corrected melting curve by subtracting the background from the raw melting curve data or from the first derivative melting curve spectra. This technique has been used primarily for genotyping applications, in which mutations in one or both alleles of a gene are detected. In these applications melting curve analysis has been used to detect dissociation of target-specific unlabelled probes from amplified DNA. Alternatively, whole amplicon melting curve analysis has been performed. In these types of applications, it is essential that the resolution of the assay is sufficient for separate detection of melting peaks occurring in the same spectrum.

Prior techniques for correcting the measured melting curve and for analyzing the melting peak areas, including those described in the abovementioned publications, are not capable of satisfactorily distinguishing between melting peaks which are situated very close to each other. In particular, improvements are needed for techniques for precise quantification of the relative amounts of nucleic acids in the sample, in particular in RNA-expression analyses.

### SUMMARY OF THE INVENTION

The aim of the present invention is to provide new techniques for accurate analysis of melting curve spectra. In particular, the aim of the present invention is to provide an improved method for relative quantification of two or more specific melting peaks present in a melting curve spectrum obtained from amplified DNA.

A further aim of the present invention is to improve instruments and software analysis for amplification and quantitative measurement of nucleic acids.

The invention has its specific focus on achieving techniques for accurate quantification of double-stranded DNA molecules, the length of which varies from 1000 to 30, in particular from 500 to 30 nucleotides. Specific advantages are obtained in studies involving molecules whose length is 100 or less, in particular 70 to 30 nucleotides.

The first aspect of the present invention is a signal-dependent method of transformation of raw melting curve data comprising the sum of the background signal and nucleic acid melt signal in order to render the data in an optimal form for final analysis. This is achieved by
optimizing one or more constants in a temperature-dependent exponential correction function to render the decrease in the sum signal intensity close to zero at a temperature region of the raw melting curve where the target nucleic acids in the sample remain essentially double stranded, and
generating a corrected nucleic acid melting curve representative of the nucleic acid melt signal using said correction function, in particular by multiplying the entire raw melting curve or its derivative, or a specific area of interest thereof, with said correction function. The absolute amount of correction is thus dependent on the fluorescent signal value at each given temperature point.

According to a preferred embodiment, the corrected melting curve is obtained directly by multiplying the measured melting curve by a correction function which is exponentially dependent on the temperature. That is, the correction function includes at least one term having an exponential behavior with respect to temperature. Thus, separate computation or subtraction of the background signal from the measured signal is not required or carried out. The corrected raw melting curve comprises the fluorescent signal related to the specific dissociation of the target nucleic acids in the sample.

According to one embodiment, the correction function C(T) includes a correction term which is proportional to K^{BT}, where K is an exponential base, T is temperature and B is a scaling factor. In particular, the correction function can be of the mathematical form given in the detailed description below. The corrected melting curve F_{corr}(T) is obtained as the product C(T)Fₘₑₐₛ(T), where Fₘₑₐₛ is the measured melting curve.

According to one embodiment, the measured melting curve is pre-processed before applying the correction function to it in order to correct a potential offset in the general level of the curve or the correction function itself includes one or more factors correcting such offset (thus, for simplicity, the terms “melting curve” and Fₘₑₐₛ can refer either to original or offset-corrected curve). This offset correction renders the area of the melting curve after the melting transition to zero or close to zero. Offset correction compensates for any systematic measurement errors and/or systematic (constant) fluorescence background that may be present.

Determination of the base K can be carried out by normalization of the melting curve at a region where no dissociation of target nucleic acids occurs. This can in practice be implemented by optimizing the correction factor (K), so as to render the change in the background signal close to zero over the non-dissociating region. For example, minimum sum or least squares method can be utilized for the optimization of K. After that, the K-based correction function dependent on temperature (or temperature difference with respect to a predefined starting point) at each point is applied to all points of the melting curve or a specified portion thereof.

For obtaining a melting peak curve, the derivative, typically a negative derivative, of the corrected melting curve is calculated. It is appreciated by a person skilled in the art that an equivalent to the above-described correction method is a method where a corresponding correction is carried out to an already derived curve. The derivative of a product rule may be applied for obtaining a correction function suitable for this case. That is, the order of steps is not critical.

The above-described approach provided significant advantages over prior art. Exponential correction function as a multiplier of the measured melting curve produces a background-corrected melting curve having a steep melting region, the derivation of which further produces a melting peak curve where closely-situated peaks are narrow and well distinguishable. In addition, the correction takes into account that the measured signal level per molecule at a higher temperature is lower than at a lower temperature. As can be seen in the detailed description, the present method compensates for this phenomenon and causes the higher-temperature peak to be corrected upwards more than the lower-temperature peak, thus producing accurate data for further analysis.

Special advantages of the present invention are obtained in specific analytical applications. For example, in genotyping applications using high resolution melt protocols for detection of single nucleotide polymorphisms, the sequence difference between analyzed nucleic acids are minimal and the difference in melting temperature are typically less than 2° C. In this type of application the distance between melting peaks is partially dictated by the natural nucleotide sequence of the target template. This results in partially overlapping peaks in subsequent melting curve spectra. When analyzing mRNA expression in a sample using a competitive PCR technique such as Genome-Controlled RT-PCR it is preferable that the difference in the nucleotide sequence of wild type and reference PCR amplicons is minimal in order to ensure close-to-identical amplification efficiency of the co-amplified templates. Generally, in this type of assay, competitively amplified templates of less than 100 nucleotides in length, typically differing in nucleotide composition by 3-7 bases, which results in a 2-5° C. difference in melting temperature of the respective PCR amplicons are quantified. In this type of application the distance between the specific melting peaks can be adjusted to some extent. The size of the peaks, however, vary considerably depending on the original amounts of wild type and reference templates in the sample. Significant variations in peak size can cause overlapping of peaks even when the distance between adjacent peaks in a melting curve spectrum is greater than 3° C. Regardless if the overlapping of adjacent peaks is caused by a small difference in melting temperature or by significant variations in peak size, such peaks can be efficiently and conveniently analyzed using the aspects of the present invention.

The second aspect of the present invention is a method for calculating the area of the separate melting peaks in a spectrum by a curve fitting algorithm to obtain a precise mathematical estimation of the areas of the independent, partially overlapping melting peaks in the spectrum. The peak areas based on curve fits are used instead of actual peak areas to calculate the relative amounts of PCR amplicons present in the sample subsequent to the amplification reaction.

The benefit of sequentially estimating peak areas by curve fitting, rather than from the actual peaks is that the areas of partially overlapping peaks in a spectrum can be precisely estimated. This is especially beneficial in situations where there is a overlapping of adjacent peaks due to considerable difference in areas of adjacent peaks and/or when the difference in melting temperature between separate amplicons is small. This results in accurate quantitative measurement of relative peak areas, which is fundamental for quantitative measurement of gene expression using competitive amplification techniques. Typically, in this type of assay, the melting temperatures of the specific PCR amplicons in the samples are known. This allows for pre-determining melting windows, where upper and lower temperature boundaries for the independent specific melting peaks are defined. This allows for automation of the assay analysis by automated detection and curve fit of multiple specific melting peaks present in the same spectra.

In competitive PCR techniques, the wild type template is co-amplified with one or multiple reference templates in the same reaction, with the same pair of PCR primers. The amplification of these templates is equally affected by variations in amplification efficiency between separate reaction vials. Thus, the amount of wild type template originally present in the sample prior to amplification can be determined from the ratios of wild type and reference PCR amplicons present after amplification. We have observed that a calibration curve consisting of serial samples with a linearly increasing amount of wild type template and a constant amount of reference template generated with this type of assay will have a sigmoid shape. In order to maximize the dynamic range of the assay it is beneficial to perform a mathematical transformation of the quantitative data that renders the calibration curve linear.

The third aspect of the present invention is a method for calculating the absolute amount of nucleic acid template molecules present in a sample prior to amplification. A calibration curve is generated for each of the analyzed genes by performing competitive amplification of samples with linearly increasing amounts of wildtype template and a constant amount of reference template or vice versa. Mathematical correction of the raw melting curves and estimation of the relative peak areas using a curve fitting algorithm can be performed as described above. A Logit-Log transformation of the obtained data is performed and a calibration curve is generated. There is a linear dependency between the Logit(p) value (Log(p/(1−p)) of the relative peak area estimates and the logarithm Log R of the relative amount of wild type and reference templates R. The Logit-Log transformation linearizes the calibration curve and thus significantly increases the dynamic range of the assay. After the transformation, the necessary parameters, that is, the linear regression slope and y-intercept values are calculated and stored in a database separately for each gene. When the absolute amount of reference template is known, the unknown amount of wild type template molecules present in a sample prior to PCR amplification, can be calculated from the relative melting peak areas of wildtype and reference amplicons, using the gene-specific slope and y-intercept values.

Logit-Log transformations have been extensively utilized for similar purposes in immunological assays. An example of this is presented in WO publication 2002/076343. We have observed that this type of mathematical transformation is applicable to assays based on PCR, in particular competitive PCR, despite the exponential nature of PCR amplification. In such assays a constant amount of a reference DNA template competes with a wild type template for DNA polymerase binding sites. This situation has proven to be analogous to an immunological assay, in which, a constant amount of labelled antigen competes with the antigen in the sample for antibody binding sites. It should be noted that the present idea of using the Logit-Log transformation in competitive PCR can be extended to other non-immunological PCR-employing applications for calculating amounts of template molecules, in particular in situations where two or more analytes compete for binding sites. This is the case with two templates and a polymerase in competitive PCR.

Each of the three main aspects of the present invention discussed above are independently beneficial for relative quantification of nucleic acids using melting curve analysis. These three aspects of the present invention can be used independently, or together in groups of two or three to gain maximal precision of the quantitative analysis. All three aspects of the present invention can be used in any melting curve assay using fluorescent or luminescent detection in which the sample comprises two or more nucleic acid molecules with separate specific melting temperatures. Examples of such techniques are quantitative and/or competitive PCR techniques such as those described in publications: Wang, A. M. et al., Proc. Natl. Acad. Sci. 86, 9717-9721 (1989), Becker-André, M. & Hahlbrock, K. Nucl. Acids Res. 17, 9437-9446 (1989), Gilliland, G. et al., Proc. Natl. Acad. Sci. 87, 2725-2729 (1990) and Stenman, J. et al., Clin. Chem. 52:11 1988-1996 (2006). Additional examples are various genotyping applications, examples of which are given in WO 2007/035806 and techniques for quantitative analysis of differentially expressed alleles based on single nucleotide polymorphisms as described in Kuokkanen M, et al., Gut 52, 647-652 (2003) and techniques for quantitative analysis of differentially expressed highly homologous genes as described in Stenman, J et al., Nat. Biotechnol. 17, 720-722 (1999). The first and second aspects, or portions thereof, can also be employed for samples containing only a single nucleic acid.

The invention can be used, for example, for the determination of relative amounts of mRNA transcripts in a cell or tissue sample. When using the Genome-Controlled RT-PCR technique for this purpose, sequence-modified cDNA templates are co-amplified competitively with one or several reference DNA templates using the same PCR primers. In this technique it is possible to use Genomic DNA (gDNA), synthesized or cloned DNA oligomers or polymers as a reference DNA template in order normalize for the differences in amplification reaction efficiency between separate reaction vials.

By using melting curve analysis to measure the relative amount of sequence-modified cDNA and reference DNA amplicons during PCR cycling or after amplification, the relative amounts of mRNA transcripts originally present in the sample can be determined. As cDNA and reference DNA templates are amplified using the same primers in the same reaction vials, the relative amount of the respective amplicons remain unchanged even when amplification reactions are run to the plateau phase. This can be utilized by running reactions to the plateau phase in order to bring the signal into the measuring range of the assay regardless of the amount of starting template present in the sample. This type of technique is presented extensively in WO publication 2005/116248, the essential contents of which are incorporated herein by reference.

Analogously, the invention can be used in an assay for determination of relative amounts of highly homologous mRNA or DNA templates naturally present in a sample by reverse transcription of mRNA templates and competitive co-amplification of cDNA and/or DNA templates and quantitative detection by melting curve analysis.

Next, embodiments and advantages of the invention are described with the aid of the attached drawings.

### BRIEF DESCRIPTION OF DRAWINGS

FIGS. 1a-1d show the determination of a correction factor for the melting curve correction function according to one embodiment of the invention.

FIG. 2 shows exemplary melting peaks generated by calculating the negative derivative of the measured melting curve −dFₘₑₐₛ/dT corrected melting curve −dF_{corr}/dT.

FIGS. 3a-3f illustrate the fitting of gauss functions to corrected melting peaks of two amplicons present in the sample.

FIGS. 4a and 4b illustrate, respectively, a Log-Log plot of a standard curve and Logit-Log plot which linearizes the entire range of the standard curve (gene: dd3).

### DETAILED DESCRIPTION OF EMBODIMENTS

As discussed above, the method according to first aspect of the invention comprises analyzing a nucleic acid melting curve measured from a sample, the melting curve comprising a sum signal of at least two nucleic acid melt signals and a background signal as a function of temperature. The method further comprises optimizing at least one constant in a temperature-dependent exponential correction function so as to minimize the variation of the nucleic acid melting curve at a temperature region where the target nucleic acids in the sample remain essentially double stranded, and generating a corrected nucleic acid melting curve representative of the nucleic acid melt signal by applying said exponential correction function over the region of the measured melting curve where the strands of the nucleic acids dissociate. According to further aspects, the invention relates to a curve fitting algorithm for precise estimation of melting peak areas and a mathematical transformation for linearization of calibration curve data to enhance the linear measuring range of a competitive PCR assay. In summary. the invention provides powerful tools for analyzing PCR-amplified sample containing two or more different nucleic acids having similar but distinguishable melting temperatures.

### DEFINITIONS

The term “PCR amplicon” means the PCR product of any PCR-amplifiable template molecule. In the context of competitive PCR, the term generally means the PCR product generated by amplification of a specific cDNA or DNA template. In techniques based on competitive PCR, separate amplicons are derived from wild type and reference templates that are co-amplified in the same reaction with the same primers.

The term “wild type template” means a nucleic acid template that is being analyzed. Wild type cDNA templates are generated during reverse transcription of mRNA species present in the original sample, whereas, a wild type DNA templates occur naturally in the original sample. The amount of wild type template is usually unknown prior to analysis.

The term “reference template” means a nucleic acid template that is included in each amplification reaction and serves to normalize for tube-to-tube variations in amplification efficiency. In the context of Genome-controlled RT-PCR, the reference DNA templates comprise genomic DNA contained in or added to the sample, or a pool of gene-specific templates such as cloned or synthesized DNA oligo- or polynucleotides for each of the analyzed genes. The wild type and reference templates in an individual amplification reaction are co-amplified in a competitive manner, using the same primers. Gene-specific synthetic or cloned reference templates can be concatenated by ligation or other means to form a single polynucleotide that serves as a universal reference template for several genes.

The term “co-amplification” means simultaneous amplification of two or more templates. For example in competitive PCR, the co-amplified templates may be cDNA and/or DNA templates with differing nucleotide sequences within the generated amplicons. A pre-requisite for co-amplification as the term is used in this patent application is that templates have identical nucleotide sequences at the primer-binding sites used in the amplification reaction and that amplification of said templates is carried out in a competitive manner with the same primers and other reagents, in the same reaction vial.

### Correction of Measured Melting Curve

As briefly explained above, in the first aspect of the invention, the background fluorescence is estimated from the initial portion of the raw melting curve prior to the specific nucleic acid melting transition where the amplified nucleic acids remain essentially double-stranded. An exponential correction factor is calculated on the basis of the initial portion of the melting curve. The entire measured fluorescence curve is thereafter multiplied by a function of temperature in which said exponential correction factor is incorporated. This transformation renders the average derivative of the background signal close to zero. If the melting experiment includes several samples, as is typically the case, the transformation is performed separately for each independent sample taking into account the amount of signal present in each individual sample.

Thus, in general terms, the method according to one embodiment comprises the following steps:
A correction factor K, which is the base in an exponential correction function, is optimized in order to render the change in background signal intensity close to zero over the range prior to the specific nucleic acid melting transition.
The correction function is applied to every temperature point in the melting curve to generate a corrected melting curve.

Optimization of the correction factor K is performed using the data of the measured melting curve at a temperature range prior to the specific nucleic acid melting transition. The minimum range width required depends on the frequency of the temperature data points obtained, which is a functional feature of the specific instrument used. Basically, a slope can be formed using a minimum of two data points, but preferably three to five data points are used to obtain more reliable results. The range typically has a width of at least 1° C., in particular at least 3° C., and preferably at least 6° C., In this fashion, the fluorescent signal used for estimation of background fluorescence is not affected by melting of the specific nucleic acids in the sample. This ensures that the proportion of background fluorescence in the sample is correctly estimated.

The present method, renders the background fluorescence close to zero and enhances the dynamic range at the specific nucleic acid melting transition. We have observed that this type of correction gives a precise estimation of the sample-derived signal obtained from temperature-specific dissociation of the DNA strands of the PCR amplicons in the sample. When the correction is performed for two adjacent melting peaks with seemingly identical areas, the correction renders the area of a peak obtained at a higher melting temperature larger than that of a peak obtained at a lower melting temperature. This is due to the fact that the fluorescent signal per molecule of DNA is temperature-dependent.

According to a preferred embodiment, the correction obeys the formula

$${F}_{corr} ( T ) = \frac{1 + {K}^{dT}}{2} {F}_{meas} ( T ) \qquad ( 1 )$$

which can also be written in the following form:

$${F}_{corr} ( T ) = ( \frac{1 + A {e}^{BT}}{2} ) {F}_{meas} ( T ) \qquad ( 2 )$$

where Fₘₑₐₛ(T) is the measured melting curve, dT=T−T₀ and constants A and B are defined as follows: B=ln K and A=e^{-BT}^{₀}.

Even more generally, the correction can be formulated as

F_{corr}(T)=(C₁+C₂e^{C}^{₃}^{T})Fₘₑₐₛ(T) (3)

where C₁, C₂ and C₃ are constants. The correction function can be calculated according to the above-described optimization principle for C₃ after fixing C₁ and C₂.

As appreciated by persons skilled in the art, the exponential correction term can be mathematically formulated in various ways.

The parameter T₀ can be relatively freely chosen from the range before the melting transition, as it only defines the starting point of correction and the correction equation is designed to yield F_{corr}(T₀) Fₘₑₐₛ(T₀).

A typical melting curve spectrum is generated by calculating the negative derivative of the corrected raw melting curve −dF/dT. A benefit of the invention in comparison with earlier techniques is that the entire melting curve is corrected for the effect of background fluorescence which allows for precise measurement of multiple specific melting peaks over the entire range of the melting curve.

In practice, the fluorescence measurements are carried out at discrete steps and the measurement results stored in an array. The calculation of the correction factor can thus be performed by discrete mathematical methods by a computer program product designed for this purpose or in a spreadsheet program.

In the following, calculation of the corrected melting curve using the abovementioned formula is described in detail.

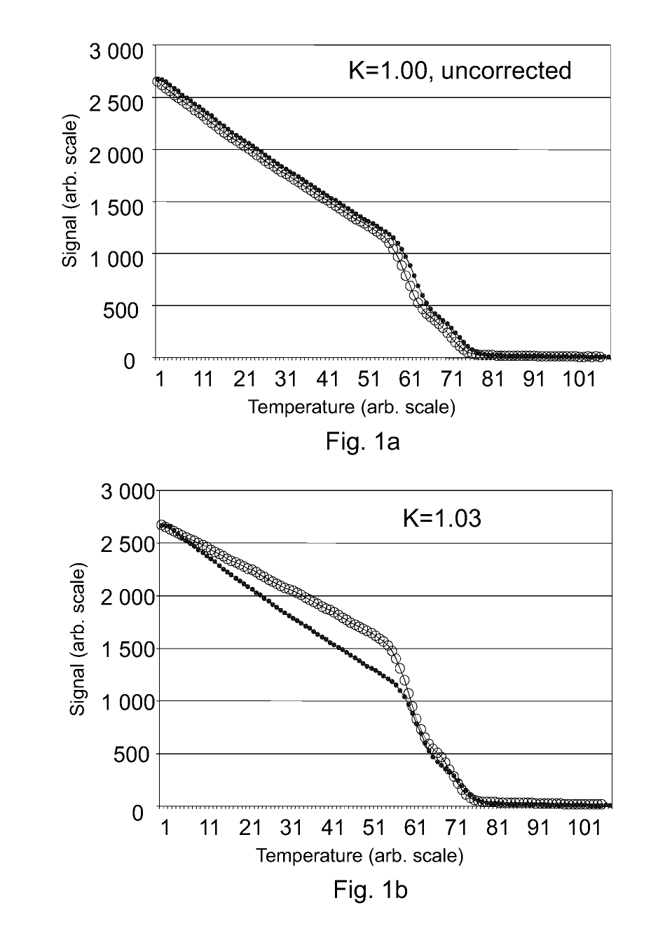

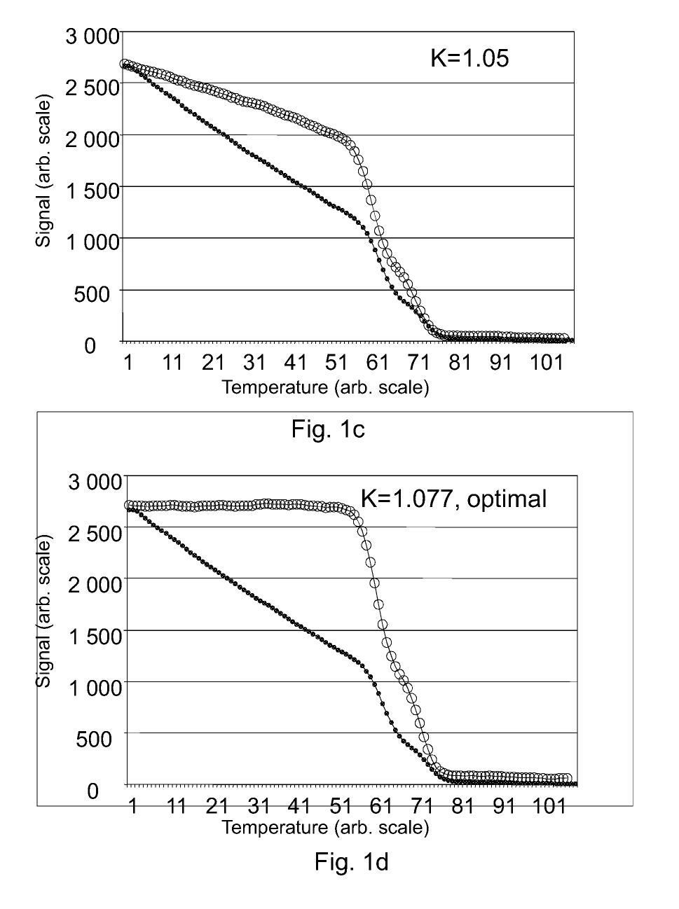

FIGS. 1a-1d illustrate the optimization of the correction factor K using the formula (1) above. The factor is gradually increased to find the optimal value, which normalizes the corrected curve at the initial part of the curve. FIG. 1a shows a situation where no correction is performed (K=1). FIG. 1d shows an optimal correction (K=1.077) which normalizes the non-dissociating region of the melting curve. This value is chosen for the K-value for correction of the whole curve using the same formula. Minimizing the sum of deviations of the curve from normal level can be implemented using first-order sums or e.g. least squares method.

It is also understood that other method for finding the optimal K-value can be used. These may include e.g. iterative or other computational methods.

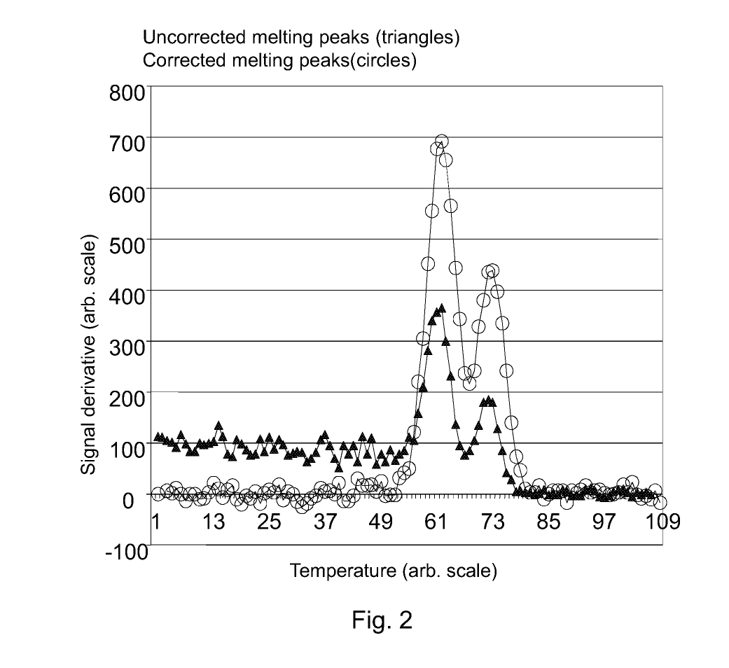

FIG. 2 shows the first negative derivatives of an uncorrected and corrected melting curve. As can be seen from the data, the correction causes the relative heights of the peaks of different amplicons to change. In the uncorrected data, the ratio of peak heights is 184.5/365.5=0.50 and in the corrected data the ratio is 438.7/691.6=0.63. As the rise in temperature causes the measured signals to weaken, the correction can be found to rectify the data in this respect. Thus, the following calculation of the proportions of the amplicons in the sample is more accurate.

The analysis is preferably performed utilizing a computer program that is run in the central processing unit of a computer. The following preparational steps can be performed prior to the analysis:
The temperature and fluorescence data are retrieved from the memory unit of the computer or directly from the instrument performing the sample melting and signal acquisition,
the melting temperature range of the wild type and the reference amplicons and preferably the identification number or name of the analysis are retrieved from a database or received from the user, and
appropriate start and end points are determined from the temperature and fluorescence data if these include excessive data points.

### Calculating the Proportions of Amplicons

The relative amounts of amplicons in the sample can be calculated from the corrected melting curve using curve fittings representing the amounts of amplicons, rather than directly using the measured first derivative melting curve peaks.

In this method, a curve fit is performed for the first peak in the corrected first derivative melting curve spectrum in order to obtain a mathematical estimation of the area of the first melting peak. Subsequently the difference of the corrected first derivative melting curve and said curve fit is calculated to obtain a residual corrected melting curve. A second curve fit is performed for the second peak in the residual melting curve to obtain a mathematical estimation of the area of the second melting peak. This procedure is repeated as many times as required in order to estimate the areas of each of the specific melting peaks in the spectrum. The areas of the curve fits for the separate melting peaks are used to determine the relative concentrations of PCR amplicons present in the sample. In competitive PCR such as the Genome-Controlled RT-PCR technique the relative concentrations of wild type and reference DNA amplicons reflect the amount of wild type cDNA and reference DNA originally present in the sample prior to amplification. In a modification of this technique two or multiple separate reference DNA templates added at different known concentrations to the sample can be co-amplified with the wild type cDNA template. In this manner a sample-specific calibration curve can be obtained from each individual amplification reaction, which further increases the quantitative precision of the analysis.

In the Genome-Controlled RT-PCR technique PCR amplicons are typically in the range 30-70 nucleotides in length. The melting temperature of reference DNA templates is typically modified by a nucleotide substitution without altering the length of the subsequent PCR amplicons. This results in a difference in the melting temperatures of wild type and reference DNA PCR amplicons of less than 5° C. When using competitive PCR and melting curve analysis for genotyping applications or for quantification of the expression level of differentially expressed alleles based on single nucleotide polymorphisms, the difference in melting temperature between the amplicons are typically less than 3° C. In addition, there is a degree of inherent temperature variation across the thermal block of many instruments currently being used for nucleic acid melting. As a result the melting peaks of a specific nucleic acid will appear at slightly different temperatures in the melting curve spectrum, depending on where the sample has been situated in the block.

Adjacent melting peaks that overlap cause significant skewing. In particular, a peak adjacent to a significantly larger peak often appears only as a shoulder on the larger peak. In such a situation the estimation of actual peak areas is difficult and imprecise. The curve-fitting procedure of the present invention allows precise estimation of the relative amount of amplicons present in the sample, in particular when there is partial overlapping of adjacent peaks and/or when difference in peak areas is large.

The method of the present invention can be processed in a separate computer, which typically forms part of a quantitative PCR system, or in the central processing unit of the PCR cycling or melting curve instrument itself.

### Example

This example illustrates the various aspects of the invention by describing the main steps of a melting curve analysis wherein the sample contains two nucleic acids having different melting temperatures.

### a) Correction of the Melting Curve

Below is presented an example of calculation of the correction from two separate temperature points on the melting curve using the principles disclosed above. Values of a pre-specified temperature range where no dissociation of specific nucleic acids occur are used for generating an optimal correction of the entire melting curve. Herein, T₀=59.3 (° C.), corresponding to the starting temperature for recording of data in the measurement.

TABLE 1
Example of correction of a measured melting curve
(at non-dissociating region)

| point | Temp | Fₘₑₐₛ | dT | (1 + K\hat{ }dT)/2 | F_{corr} |
|---|---|---|---|---|---|
| 1 | 59.3 | 0.1536 | | | 0.1536 |
| 12 | 62.2 | 0.1372 | | | |
| 13 | 62.5 | 0.1355 | 3.2 | 1.1328 | 0.1535 |
| 24 | 65.8 | 0.1176 | | | |
| 25 | 66.1 | 0.1155 | 6.8 | 1.3249 | 0.1530 |

Table 1 demonstrates that using the optimized correction factor K in the correction function (1+K̂dT)/2 renders the corrected fluorescence values close-to-equal at temperatures below the melting transition of the target nucleic acids in the samples. After correction the raw (non-derived) melting curve will be horizontal, i.e. normalized at the non-dissociating region. The behaviour of the corrected curve at the dissociating region and after that is shown in the drawings.

### b) Determination of Melting Peak Areas

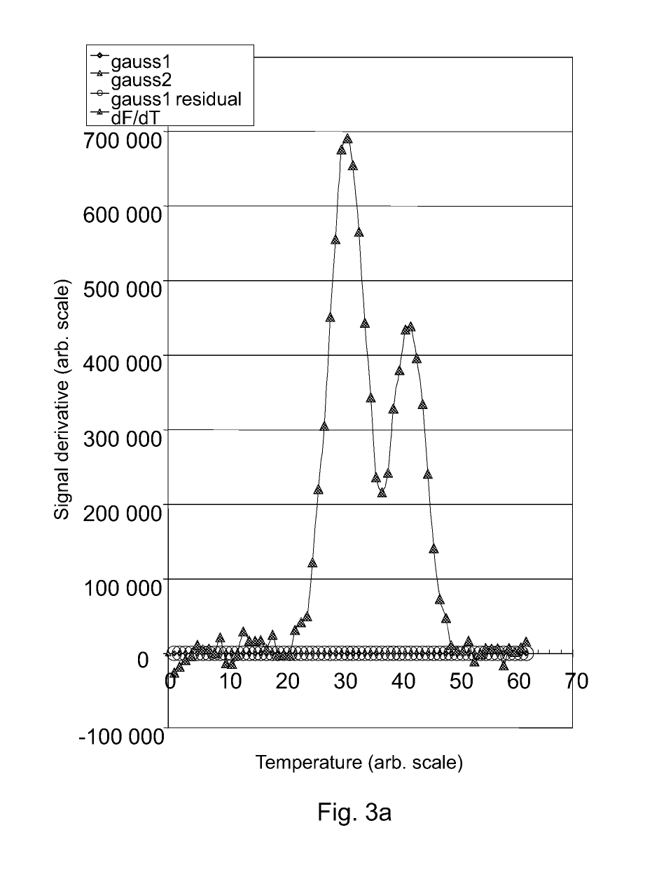

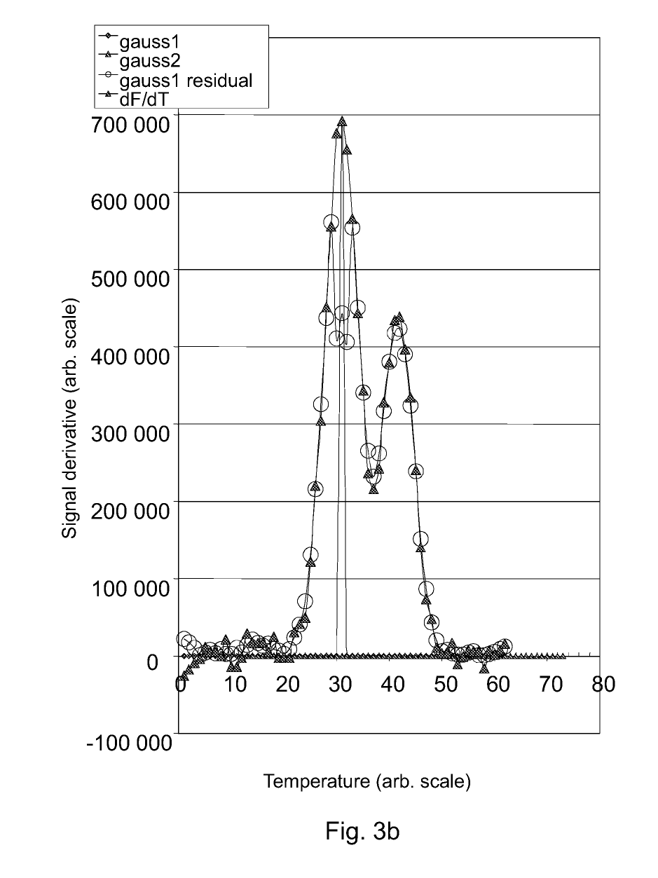

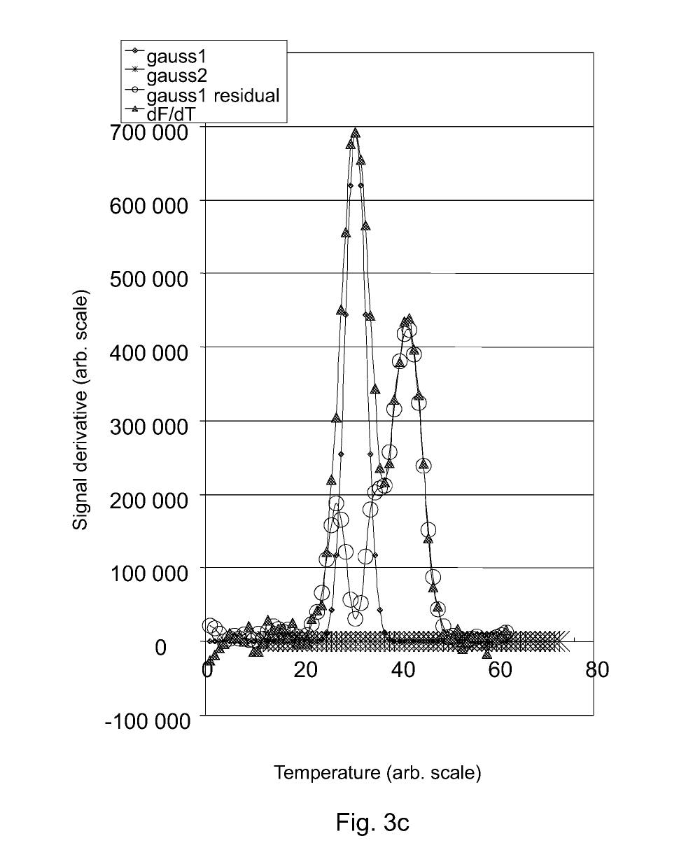

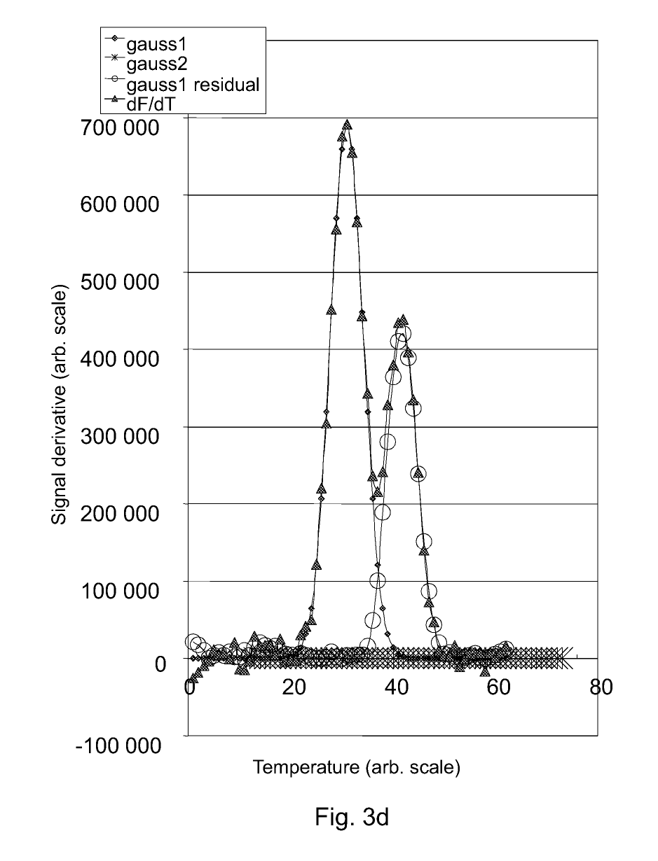

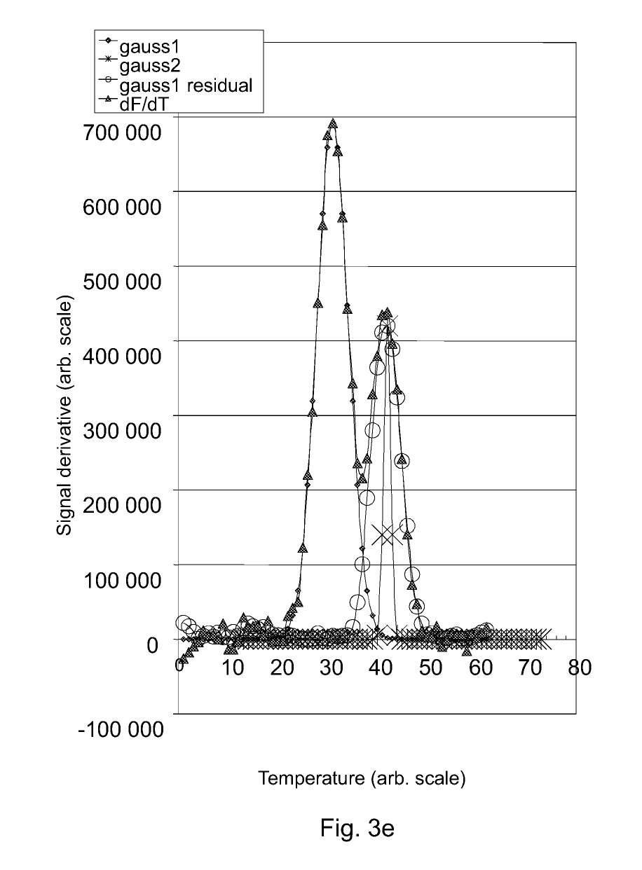

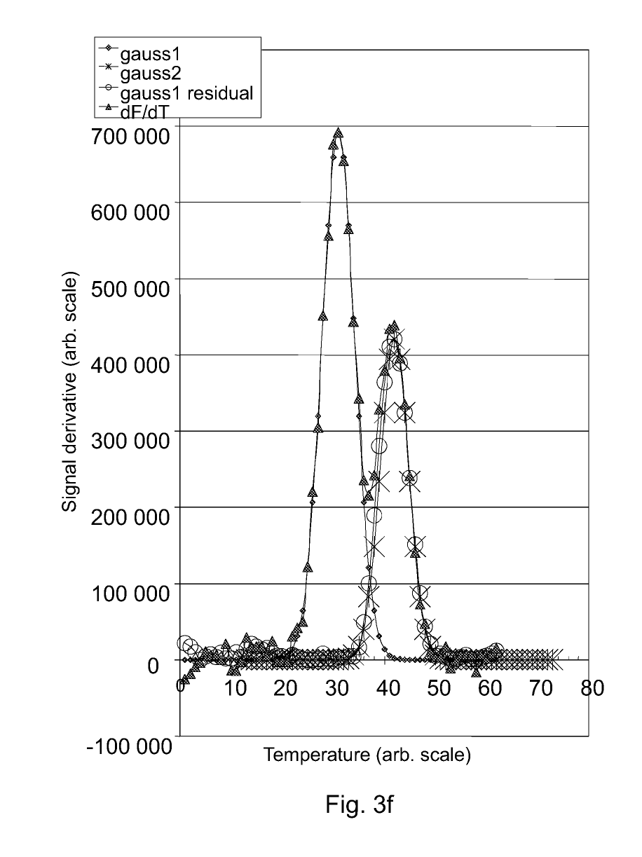

Measurement of the areas of the specific melting peaks can be carried out by
determining the location of maximum rate of change in corrected signal strength, e.g. by finding the maximum value of the derivative for the first nucleic acid occurring in the melting curve (for this purpose pre-determined melting temperature ranges for the respective amplicons can be utilized),
performing a curve fit for the first melting peak, for example by optimizing the width of a chosen curve form (i.e. gaussian) to fit the peak, i.e., until a minimum for the difference of the curve and the first melting peak (i.e., residual curve) is found (this is illustrated in FIGS. 3a and 3b (showing a non-optimal fit) and FIG. 3c (showing an optimal fit)),
when the width of the curve has been determined to fit the first nucleic acid melting peak, the difference of the measured value−value of said curve in each data point of the entire derivative melting curve is calculated to generate a residual melting curve (FIG. 3c),
determining from the residual melting curve the peak of the second nucleic acid by finding the maximum change of rate of the signal, e.g. by finding or the maximum value of the derivative for the second nucleic acid occurring in the melting curve (for this purpose pre-determined melting temperature ranges for the respective PCR amplicons can be utilized),
performing a curve fit by optimizing the width of a curve (i.e. gaussian) to fit the peak of the second nucleic acid in the first derivative melting curve by using said maximum value as the maximum for the curve (FIGS. 3e (non-optimal fit) and 3f (optimal fit)),
if more than two nucleic acids are present, repeating these steps are until a curve fit has been performed for each of the specific nucleic acid melting peaks in the sample,
optionally, first derivative melting curves and/or the goodness of the curve fit and/or the calculated residual melting curves are graphically displayed and,
calculating the areas of each of the fitted curves and using these areas to estimate the relative amounts of the respective amplicons present in the sample.

Automation of the curve fittings is generally possible using the above algorithm, However, the fittings can also be performed fully or partly manually, if desired.

### c) Calculating the Absolute Amounts of Nucleic Acids in the Sample

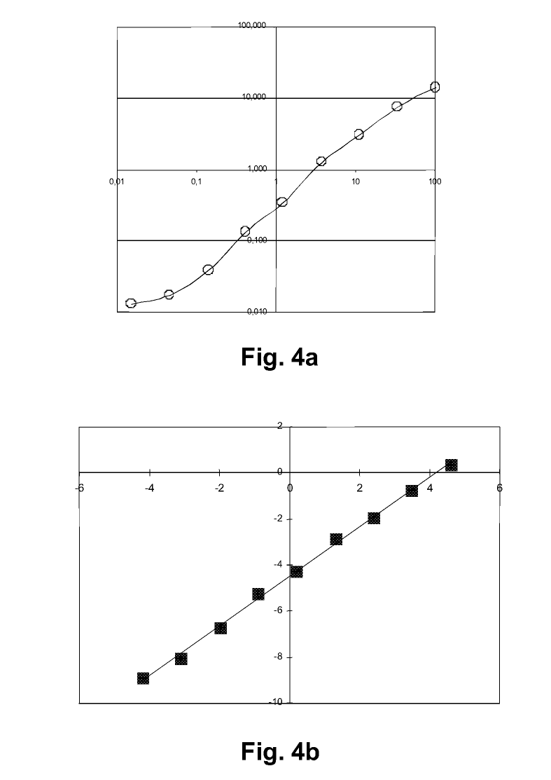

In one embodiment of the present invention a calibration curve is generated in order to enable quantification of the unknown absolute amount of wildtype template molecules present in the sample prior to amplification. This calibration curve is generated by performing amplification of samples with known wild type/reference template ratios at constant increments. A Logit-Log transformation where the logit of a number p between 0 and 1 is given by the formula logit(p)=log(p)−log(1−p) is performed to linearize the sigmoidal calibration curve. The linear regression slope and y-intercept values of the linearized calibration curve are calculated and stored in a data base. These values are used to calculate the unknown absolute amount of wild type template present in the sample prior to amplification from the Logit-Log transformed ratio of wild type and reference amplicon-derived melting curve areas in a sample. This is achieved by:
co-amplifying a linearly increasing amount of wild type template with a constant amount of reference template in serial samples. For this purpose synthetic or cloned DNA oligo- or polynucleotides with the same nucleotide composition as the wildtype and reference templates can be used,
performing melting curve analysis of the amplicons to obtain the ratio of cDNA and reference DNA-derived melting curve areas from each of the serial samples to generate a calibration curve (preferably, but not necessarily, the melting curve correction and/or melting peak area calculation according to other aspects of the invention are used),
performing Logit-Log transformation of the relative curve areas in order to linearize the calibration curve, (FIG. 4a shows the sigmoidal calibration curve (gene: dd3) as a Log-Log graph, FIG. 4b shows the calibration curve after Logit-Log transformation)
calculating the linear regression slope and y-intercept values from the calibration curve and storing these in a database, separately for each gene included in a subsequent analysis,
using the gene-specific slope and y-intercept values to calculate the unknown absolute amount of wild type template molecules originally present in a sample, from the sample-specific ratio of wild type and reference amplicon-derived melting curve areas

As can be seen from FIG. 4a, the Log-Log plot of the standard curve is typically sigmoidal, but the Logit-Log function, shown in FIG. 4b linearizes the entire range of the standard curve (gene: dd3). Thus, the linear dynamic range of the analysis is increased.

The basic mathematical principles of Logit-Log transformation, however, in the context of radioimmunological assay, is presented in Rodbard D. et al, Mathematical analysis of kinetics of radioligand assays: improved sensitivity obtained by delayed addition of labeled ligand. J Clin Endocrinol Metab, 1971 August; 33(2): 343-55.

The embodiments described above and shown in the attached drawings are given for illustrative purposes and are not intended to limit the scope of the present invention which is defined in the following claims.

1. A method for analyzing a sample containing at least one nucleic acid using a nucleic acid melting curve measured from the sample, the melting curve comprising a sum signal of nucleic acid melt signal and a background signal as a function of temperature, the method comprising
optimizing at least one constant in a temperature-dependent exponential correction function so as to minimize the variation of the nucleic acid melting curve at temperature region where the nucleic acids in the sample remain essentially double stranded, and
generating a corrected nucleic acid melting curve representative of the nucleic acid melt signal by applying said exponential correction function over the region of the measured melting curve, or derivative thereof, where the strands of the nucleic acids dissociate.

2. The method according to claim 1, wherein the measured melting curve is multiplied with the exponential correction function in order to obtain said corrected melting curve.

3. The method according to claim 1, wherein the corrected nucleic acid melting curve is generated by multiplying the measured nucleic acid melting curve at the region of the measured melting curve where the strands of the nucleic acids dissociate by an exponential function including a term K^{T}, or a mathematical equivalent thereof, wherein K is a constant correction factor being optimized using data from the region of the melting curve where no dissociation of target nucleic acids occurs.

4. The method according to claim 1, wherein the correction obeys the formula
$${F}_{corr} ( T ) = \frac{1 + {K}^{dT}}{2} {F}_{meas} ( T ) ,$$
where F_{corr}(T) is the corrected melting curve, Fₘₑₐₛ(T) is the measured melting curve, dT=T−T₀, where T₀ is a predefined starting temperature and K is a constant optimized using the measured melting curve at the temperature region where the target nucleic acids in the sample remain essentially double stranded.

5. The method according to claim 1, wherein the optimization of the constant in the correction function is performed over a temperature range having a width of at least 1° C., in particularly at least 3° C., preferably at least 6° C.

6. The method according to claim 1, wherein a derivative of the corrected melting curve is calculated in order to obtain a melting peak curve.

7. The method according to claim 1, wherein the nucleic acid melting curve is measured from a sample processed by PCR amplification, in particular competitive PCR amplification.

8. The method according to claim 1, wherein the sample contains two or more different nucleic acids having different melting temperatures.

9. The method according to claim 8, wherein the nucleic acid melting curve is measured from a Genome-Controlled RT-PCR sample containing a wild type cDNA and reference DNA nucleic acids.

10. The method according to claim 8, wherein the difference of the inciting temperatures of the at least two different nucleic acids is less than 10° C., in particular less than 5° C., preferably 0.5-5° C.

11. The method according to claim 8, wherein the length of each of the at least two nucleic acids is less than 500 nucleotides, advantageously less than 100 nucleotides, in particular 30-70 nucleotides.

12. The method according to claim 8, further comprising the steps of
calculating a first derivative of the corrected melting curve in order to form a melting peak curve,
determining the areas of at least two melting peaks of the melting peak curve,
calculating the proportions of nucleic acids in the sample using said areas.

13. A system for analyzing melting properties of nucleic acids, comprising
means for measuring a nucleic acid melting curve as a function of temperature, the melting curve comprising a sum signal of nucleic acid melt signal and a background signal,
computing unit for analyzing the measured melting curve, and
means for transferring the measured melting curve to said computing unit,
wherein the computing unit comprises
means for optimizing at least one constant in a temperature-dependent exponential correction function so as to minimize the variation in the sum signal intensity at a temperature region where the nucleic acids in the sample remain essentially double stranded, and
means for generating a corrected nucleic acid melting curve representative of the nucleic acid melt signal by applying said exponential correction function over the region of the measured melting curve, or derivative thereof; where the strands or the nucleic acids dissociate.

14. The system according to claim 13, wherein the computing unit is adapted to the multiply the measured melting curve with the exponential correction function in order to obtain said corrected melting.

15. A computer program product stored on a computer-readable medium for analyzing nucleic acid melting curves, the product being configured to
read measured melting curve data including temperature values and corresponding signal values from a data file,
optimize, based on said data, at least one constant in a temperature-dependent exponential correction function so as to minimize the variation in the sum signal intensity at a temperature region where the nucleic acids in the sample remain essentially double stranded
calculate a corrected nucleic acid melting curve using said exponential correction function over the region of the measured melting curve, or derivative thereof, where the strands or the nucleic acids dissociate.

16. (canceled)

17. A method for determining the proportions of nucleic acids from a melting curve measured from a sample containing at least two nucleic acids, the method comprising
correcting the measured melting curve by removing the effect of background signal so as to form a corrected melting curve reflecting melting of the target nucleic acids in the sample,
calculating a first derivative of the corrected melting curve in order to form a melting peak curve,
fitting mathematical functions, for example gaussian functions, to the melting peaks contained in the melting peak curve,
estimating the areas of the melting peaks using said fitted mathematical functions, and
determining the proportions of nucleic acids in the sample using said areas.

18. The method according to claim 17, wherein said fitting is performed by
fitting a first mathematical function to a first peak found on the melting peak curve for estimating the first melting peak,
calculating a residual curve by subtracting said first mathematical function from the melting peak curve,
fitting a second mathematical function or the like to the residual curve for estimating the second melting peak, and
optionally, repeating the previous steps for estimating further melting peaks that may be present.

19. The method according to claim 18, wherein the melting curve comprises a sum signal of nucleic acid melt signal and a background signal as a function of temperature and the step of correcting the measured melting curve is carried out by
optimizing at least one constant in a temperature dependent exponential correction function so as to minimize the variation of the nucleic acid melting curve at temperature region where the nucleic acids in the sample remain essentially double stranded, and
generating a corrected nucleic acid melting curve representative of the nucleic acid melt signal by applying said exponential correction function over the region of the measured melting curve, or derivative thereof, where the strands of the nucleic acids dissociate.

20. A method for determining the proportions of nucleic acids from a melting curve measured from a sample containing at least two nucleic acids, the method comprising
correcting the measured melting curve by removing the effect of background signal so as to form a corrected melting curve reflecting real melting of the sample,
calculating a first derivative of the corrected melting curve in order to form a melting peak curve,
estimating the areas of the melting peaks, and
determining the proportions of nucleic acids in the sample by Logit-Log transformation using said areas.

21. The method according to claim 20, comprising
providing a calibration curve for quantification of the amounts of nucleic acids, the calibration curve being obtained by from samples with known nucleic acid ratios at least two known concentrations,
linearizing the calibration curve using Logit-Log transformation,
calculating necessary parameters to describe the linearized calibration curve, and
using said parameters and said estimated areas of the melting peaks to calculate the absolute amount of at least one of the nucleic acids in the sample prior to amplification.

22. The method according to claim 20, wherein the melting curve comprises a sum signal of nucleic acid melt signal and a background signal as a function of temperature and the step of correcting the measured inciting curve is carried out by
optimizing at least one constant in a temperature-dependent exponential correction function so as to minimize the variation of the nucleic acid melting curve at temperature region where the nucleic acids in the sample remain essentially double stranded, and
generating a corrected nucleic acid melting curve representative of the nucleic acid melt signal by applying said exponential correction function over the region of the measured melting curve, or derivative thereof, where the strands of the nucleic acids dissociate.

23. The method according to claim 22, wherein the proportions of nucleic acids are estimated by
correcting the measured melting curve by removing the effect of background signal so as to form a corrected melting curve reflecting melting of the target nucleic acids in the sample,
calculating a first derivative of the corrected melting curve in order to form a melting peak curve,
fitting mathematical functions, for example gaussian functions, to the melting peaks contained in the melting peak curve,
estimating the areas of the melting peaks using said fitted mathematical functions, and
determining the proportions of nucleic acids in the sample using said areas.

24. The method according to claim 1, further comprising
based on the corrected nucleic acid meting curve, quantifying relative amounts of at least two nucleic acids in the sample.

25. The system according to claim 24, wherein the computing unit is adapted to generate the corrected nucleic acid melting curve by multiplying the measured nucleic acid melting curve at the region of the measured melting curve where the strands of the nucleic acids dissociate by an exponential function including a term K^{T}, or a mathematical equivalent thereof, wherein K is a constant correction factor being optimized using data from the region of the melting curve where no dissociation of target nucleic acids occurs.

26. The system according to claim 24, further comprising means for quantifying relative amounts of at least two nucleic acids in the sample based on the corrected nucleic acid meting curve.
